(19) United States
(12) Patent Application Publication
(10) Pub. No.: US 2026/0302751 A1
(43) Pub. Date: Oct. 1, 2026

(54) POWER MODULE AND METHOD FOR PRODUCING THE POWER MODULE

(71) Applicant: MAGNA Powertrain GmbH & Co KG, Lannach (AT)

(72) Inventors: Lukas Berger, Ried in der Riedmark (AT); Amil Handukic, Steyr (AT); Rudolf Angerer, Steyregg (AT)

(21) Appl. No.: 18/998,242

(22) PCT Filed: Jul. 12, 2023
(86) PCT No.: PCT/EP2023/069373

§ 371 Date: Jan. 24, 2025

(30) Foreign Application Priority Data
Jul. 28, 2022 (DE) 10 2022 207 767.9

(51) Int. Cl. H02G 5/00

(52) U.S. Cl. CPC H02G 5/005

(57) ABSTRACT

A power module includes at least two parallel conductor bars. The conductor bars are separated from each other by an insulating foil that lies flat against the conductor bars in the longitudinal direction and the conductor bars are overmolded with an isolating injection molding material in an overmold. The insulating foil has a projection along the longitudinal direction that forms a fused connection with the injection molding material of the overmold in the overlapping region.

### CROSS-REFERENCE TO RELATED APPLICATIONS

This application is a National Stage of International Application No. PCT/EP2023/069373, filed on Jul. 12, 2023, which claims priority to DE102022207767.9 filed on Jul. 28, 2022. The entire disclosures of each of the above applications are incorporated herein by reference.

### FIELD

The present disclosure relates to a power module having a carrier substrate, at least a first and a second power semiconductor component, and conductor rails.

The present disclosure further relates to a method for producing a power semiconductor module having overmolded conductor rails.

### BACKGROUND

In automobile electronics, in particular in hybrid and electric vehicles, power modules are increasingly employed, in which power semiconductor components are arranged on a substrate. For an electrical contact-connection of power semiconductor components with printed conductors, bonding technologies are predominantly employed, for example a direct copper bonded technology.

A power module of this type can be employed for example, for an infeed of current to an electric motor, for example to a three-phase AC motor. In applications of this type, very high power losses and very high switching currents, of the order of several hundred amperes, can occur in power modules.

A power module is known from DE 10 2011 089 740 A1 which comprises an electrically insulating carrier substrate. The carrier substrate incorporates a ceramic material or is comprised of a ceramic material. The power module comprises an electrically conductive first printed conductor, which is arranged on a first surface of the carrier substrate, and an electrically conductive second printed conductor, which is also arranged on the first surface of the carrier substrate. The power module further comprises at least one first power semiconductor component, which comprises at least a first terminal and a second terminal, wherein the first terminal is arranged on a side of the first power semiconductor component which faces the first printed conductor, and the second terminal is arranged on a side of the first power semiconductor component which is averted from the first printed conductor, and the first terminal is electrically coupled to the first printed conductor. The power module moreover comprises at least one second power semiconductor component, which comprises at least a first terminal and a second terminal, wherein the first terminal is arranged on a side of the second power semiconductor component which faces the second printed conductor, and the second terminal is arranged on a side of the second power semiconductor component which is averted from the second printed conductor, and the first terminal is electrically coupled to the second printed conductor. The power module comprises an electrically conductive planar connection, by means of which the second terminal of the first power semiconductor component is electrically coupled to the second printed conductor. The power module comprises an insulating layer and an electrically conductive third printed conductor. The third printed conductor is arranged on a side of the insulating layer which is averted from the carrier substrate. The second terminal of the second power semiconductor component is electrically coupled to the third printed conductor. The insulating layer is configured and arranged such that it electrically insulates the third printed conductor from the first and second printed conductors. The first printed conductor and the third printed conductor, in the direction of the vertical axis, are arranged in at least a partially overlapping manner.

An overmolded power module is known from DE 10 2010 001 545 A1, which essentially comprises a circuit carrier which is configured e.g. as a DBC substrate of a ceramic material such as e.g. LTCC or a standard ceramic such as Al₂O₂, or which can also be configured as a punch grid. On a circuit carrier of this type, electronic components are arranged to form a circuit. The number of electronic components which are to be respectively accommodated on the circuit carrier are soldered, adhesively bonded or clip-fitted, and are then embedded in a molding compound. In general, the molding compound is sprayed around the components which are configured on the circuit carrier such that, firstly, a fastening of individual electronic components and, secondly, a sealing against external environmental influences can be achieved.

A flat power cable is known from CN 1 05 513 689 A, the conductors of which are separated by a substrate material.

### SUMMARY

The object of the present disclosure is to provide a power module that contributes to enhanced efficiency and/or reliability of the power module.

This object is achieved by the features of the present disclosure. Advantageous further developments of the present disclosure are further described herein.

The object is achieved by a power module having at least two mutually parallel conductor rails, wherein the conductor rails are separated from one another by an insulating foil which lies flat along the longitudinal direction of the conductor rails and are overmolded with an insulating injection molding material in an overmold, wherein the insulating foil has a projection along the longitudinal direction that forms a fused connection with the injection molding material of the overmold in the overlapping region.

A power module of this type is optimized with respect to its electrical properties, and reduces the risk of inductive currents.

The power module is space-saving, as a result of the combination of the insulating foil and the injection molding method.

In one embodiment, the insulating foil is arranged between the conductor rails.

In a further embodiment, the insulating foil between the conductor rails is adhesively bonded to at least one of the two conductor rails.

The insulating foil has a projection along the transverse direction of the conductor rails, which overhangs the end faces of the conductor rails in the contact region.

The thickness or gauge of the insulating foil is smaller than the thickness of the overmold, by a factor of 10-20.

The object is further fulfilled by a method for producing a power module, wherein conductor rails and an insulating foil, which is arranged between the conductor rails, are introduced into an injection-molding tool, wherein the insulating foil is retained, either in the tool or on one of the conductor rails, and wherein the conductor rails are overmolded, and the insulating foil is bonded to the overmold material by fusion. The insulating foil can be formed of the same material as the overmold.

The insulating foil can be mechanically retained, and can also be partially adhesively bonded.

### BRIEF DESCRIPTION OF THE DRAWINGS

The present disclosure is described below by way of example with reference to the drawings.

FIG. 1 shows a sectional view of two parallel-oriented conductor rails;

FIG. 2 shows a view of the parallel conductor rails.

### DETAILED DESCRIPTION

Conductor rails in power modules are frequently installed in a mutually parallel arrangement. It is thus necessary for the individual conductor rails to be insulated from one another, and from further components of the power module.

In known designs, overmolded components, which are arranged with the smallest possible clearance in relation to one another, are mutually insulated by the overmold material itself, which penetrates between the components, and thus between the conductor rails. For the introduction of an overmold material between the conductor rails, a minimum clearance between the conductor rails is required, which is dictated by the overmold material and by the injection-molding process.

In many cases, a clearance is required for this purpose which approximately corresponds to the thickness of an overmold of the conductor rails. A customary overmold assumes a thickness “d” of several millimeters.

It is thus problematic that the conductor rails are installed with a degree of tolerance, such that the minimum clearance between the conductor rails varies. It is thus difficult to execute a specific clearance vis-à-vis the overmold.

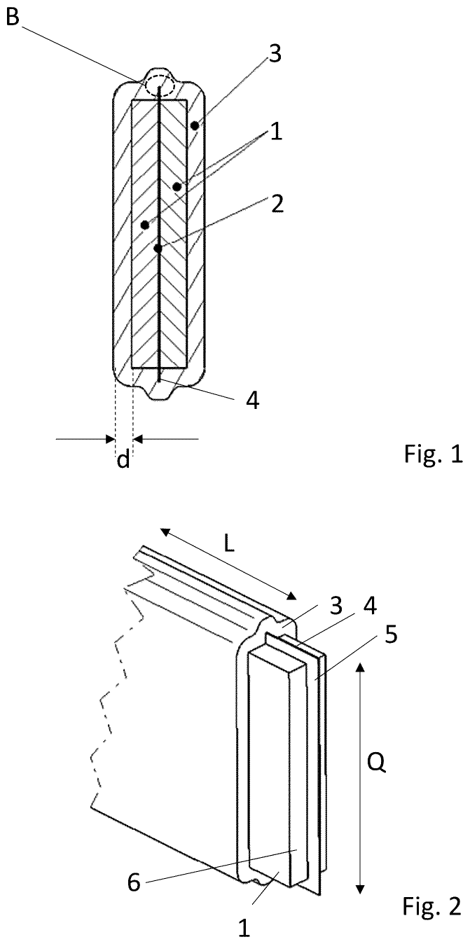

With reference to FIG. 1, according to the present disclosure, an insulating foil 2 is applied between the conductor rails 1, which assumes a small thickness in comparison with the minimum clearance with known designs, or in comparison with the thickness of the overmold 3. Insulating foils have a thickness or gauge “s” of a few micrometers. The gauge “s” is thus smaller than the thickness “d” of the overmold 3 by a factor of 10-20.

The insulating foil 2 is made of a material which is compatible with the material employed for injection-molding, and thus for the resulting overmold 3, and which can form a fused connection in transition regions.

To this end, the insulating foil 2, in one embodiment, is employed as a separate component which, in the injection-molding process, is fastened in the tool and defines the separation between the two conductor rails 1.

In an alternative embodiment, the insulating foil 2 is at least partially coated with an adhesive material, such that the foil, prior to the overmolding of the conductor rails 1, can be adhesively bonded to one of the conductor rails 1.

In a further alternative embodiment, one of the conductor rails 1 is coated with a thin insulating layer that defines the insulating foil 2.

The two parallel-oriented conductor rails 1, independently of the preparation thereof, are overmolded by the injection molding material 3, in combination with the insulating foil 2 or the insulating layer. The insulating foil 2 projects beyond the two conductor rails. This projection 4 lies in the range of 1-5 mm, and is employed for the fusion of the insulating foil 2 with the injection molded material in region B, in which the conductor rails 1 are overmolded. The overmold 3 is thickened in region B, in order to facilitate fusion.

By way of current-carrying components, conductor rails 1 of copper, aluminum, or copper alloys are employed.

In the method for overmolding the conductor rails 1, the insulating foil 2 is introduced into an injection-molding tool. The insulating foil 2 is fastened in the tool in at least one location. This can be achieved by a clamping of the foil 2, or by a permanent bonding of the foil 2 in the tool or, alternatively, to one of the conductor rails 1.

The adhesive material employed is not permitted to influence the properties of the injection molding material. The conductor rails 1 are applied to the insulating foil 2 in the tool, and extend on either side of the insulating foil 2. Thereafter, the tool is closed and the overmold 3 is formed.

FIG. 2 shows a view of the region in which the conductor rails 1 are led out of the cladding formed by the overmold 3 of the injection molding material. At this location, the insulating foil 2 has a projection 4 in the direction of the longitudinal extension L of the conductor rails 1, which is not fused, and a further projection 5 in the transverse extension Q. By way of the further projection 5, but also by way of that part of the projection 4 which is not fused, it is intended to prevent the formation of any creepage path between the current-carrying components.

What is claimed is:

1. A power module comprising:
at least two mutually parallel conductor rails,
an insulating foil which lies flat along a longitudinal direction of the conductor rails, wherein the conductor rails are separated from one another by the insulating foil and
wherein the conductor rails are overmolded with an insulating injection molding material in an overmold,
wherein the insulating foil has a projection along the longitudinal direction that forms a fused connection with the injection molding material of the overmold in an overlapping region.

2. The power module as claimed in claim 1, wherein the insulating foil arranged between the conductor rails.

3. The power module as claimed in claim 2, wherein the insulating foil between the conductor rails is adhesively bonded to at least one of the two conductor rails.

4. The power module as claimed in claim 1, wherein the insulating foil has a projection along the transverse direction of the conductor rails, which overhangs the end faces of the conductor rails in a contact region.

5. The power module as claimed in claim 1, wherein the insulating foil has a gauge that is smaller than a thickness of the overmold by a factor of 10-20.

6. A method for producing a power module as claimed in claim 1, the method comprising:
introducing the conductor rails and the insulating foil, which is arranged between the conductor rails, into an injection-molding tool,
retaining the insulating foil in the injection-molding tool or on one of the conductor rails, and
overmolding the conductor rails with the overmold material, and
bonding the insulating foil to the overmold material by fusion in the overlapping region.

7. The method as claimed in claim 6, wherein the insulating foil is mechanically retained in the injection molding tool or on one of the conductor rails.

8. The method as claimed in claim 6, wherein the insulating foil is at least partially adhesively bonded by an adhesive material to one of the conductor rails.

9. The method as claimed in claim 8, wherein the insulating foil is adhesively bonded to at least one of the conductor rails prior to the overmolding.

10. The method as claimed in claim 6, wherein at least one of the conductor rails is coated with a thin insulating layer that defines the insulating foil.

11. The power module of claim 1, wherein a region of the conductors rails extend out of the overmold in the longitudinal direction.

12. The power module of claim 11, wherein a portion of the projection extends out from the overmold in the longitudinal direction and is not fused with the overmold material

13. The power module of claim 12, wherein a further projection extends in a transverse direction of the conductor rails outside of the overmold and is not fused with the overmold material.

14. The power module of claim 1, wherein overmold material is not disposed between the conductor rails.

15. The power module of claim 1, wherein the conductor rails are spaced apart at a distance that is smaller than a thickness of the overmold.

16. The power module of claim 1, wherein the overmold has a thickness that is greater in the overlapping region relative to its thickness across a face of the conductor rails.

17. The power module of claim 1, wherein the overmold extends fully around the insulating foil and the conductor rails in the lateral direction.

18. The power module of claim 1, wherein the insulating foil is defined by an insulating layer that coats of at least one of the conductor rails.
